(19) United States
(12) Patent Application Publication
(10) Pub. No.: US 2026/0146848 A1
(43) Pub. Date: May 28, 2026

(54) DISPLACEMENT MEASURING INSTRUMENT

(71) Applicant: MITUTOYO CORPORATION, Kanagawa (JP)

(72) Inventor: Koji KUBO, Tokyo (JP)

(73) Assignee: MITUTOYO CORPORATION, Kanagawa (JP)

(21) Appl. No.: 19/402,003

(22) Filed: Nov. 26, 2025

(30) Foreign Application Priority Data
Nov. 28, 2024 (JP) 2024-207633
Nov. 21, 2025 (JP) 2025-201969

(51) Int. Cl. G01B 11/14; G06T 7/00; G06T 7/73

(52) U.S. Cl. CPC G01B 11/14; G06T 7/0002; G06T 7/73; G06T 2207/30164

(57) ABSTRACT

A displacement measuring instrument includes: a light source; a first interferometer to split a broadband source light into reference light and measurement light, to cause the reference light to be incident on a reference surface and the measurement light to be incident on a measurement surface, and to superimpose the reference light and the measurement light to generate interference light; a second interferometer to split the interference light, to cause the split interference light to be incident on a first reflection surface and a second reflection surface, and to superimpose a first reflected light and a second reflected light to generate expanded light that expands in a predetermined expansion direction; an image sensor to detect the expanded light; and a processing device to measure displacement on the measurement surface based on displacement of a peak position of an interference signal in an image detected by the image sensor.

### CROSS REFERENCE TO RELATED APPLICATIONS

The entire disclosure of Japanese Patent Applications No. 2024-207633 filed Nov. 28, 2024 and No. 2025-201969 filed Nov. 21, 2025 is expressly incorporated by reference herein.

### TECHNICAL FIELD

The present invention relates to a displacement measuring instrument.

### BACKGROUND ART

Displacement measuring instruments including an interferometer that uses a light source configured to emit a broadband light have been known. Known examples of such displacement measuring instruments include a time-domain displacement measuring instrument, spectral-domain displacement measuring instrument, and wavelength-sweeping displacement measuring instrument.

The time-domain displacement measuring instrument mechanically changes an optical path length of a part of an optical path of an interferometer and detects interference fringes generated at a part where a difference in length of the optical path between a reference light and a measurement light is zero, thereby measuring a displacement of a measurement target (see, for instance, Patent Literature 1 (JP 2017-524138 A)).

The spectral-domain displacement measuring instrument uses broadband light such as white light as a light source, causes the light to interfere by means of an interferometer, spectrally analyzes the resulting interference light to obtain frequency characteristics of light intensity, and detects a peak position of an interference signal corresponding to a wavelength (see, for instance, Patent Literature 2 (JP 2017-38997 A)).

The wavelength-sweeping displacement measuring instrument sweeps (i.e., continuously changes) a wavelength of light emitted from a light source by means of an interferometer within a short time and detects a displacement of a measurement target based on frequency characteristics and phase of a change in light intensity caused on the interference light (see, for instance, Patent Literature 3 (JP 2021-189112 A)).

The above-described time-domain displacement measuring instrument, spectral-domain displacement measuring instrument, and wavelength-sweeping displacement measuring instrument have the following respective features.

The time-domain displacement measuring instrument provides a relatively wide measurable range and high accuracy. On the other hand, the time-domain displacement measuring instrument requires mechanical operations for changing the optical path length. Due to these operations, the time required for measurement is prolonged and mechanisms for precisely changing the optical path length and the like entail a high cost.

The spectral-domain displacement measuring instrument does not require any mechanical operations but provides high accuracy. However, the measurable range of the spectral-domain displacement measuring instrument is as narrow as, for instance, 2 to 3 mm and a spectrometer and the like entail a high cost.

The wavelength-sweeping displacement measuring instrument does not require any mechanical operations and allows a relatively wide measurement range, for example, of 1 m or more. However, it entails a high cost due to the use of a variable wavelength laser or the like, and is further susceptible to temperature influences, making it difficult to achieve high accuracy.

It has been difficult for existing displacement measuring instruments as described above to simultaneously achieve high accuracy, wide measurable range, and low cost without requiring mechanical operations.

### SUMMARY OF THE INVENTION

An object of an aspect of the invention is to provide a displacement measuring instrument that can simultaneously achieve high accuracy, wide measurable range, and low cost without requiring mechanical operations.

According to an aspect of the invention, a displacement measuring instrument includes: a light source configured to generate broadband source light; a first interferometer configured to split the source light into reference light and measurement light, to cause the reference light to be incident on a reference surface and the measurement light to be incident on a measurement surface, and to superimpose the reference light and the measurement light reflected from the reference surface and the measurement surface, respectively, to generate interference light; a second interferometer configured to split the interference light, to cause the split interference light to be incident on a first reflection surface and a second reflection surface, and to superimpose a first reflected light reflected by the first reflection surface and a second reflected light reflected by the second reflection surface to generate expanded light that expands in a predetermined expansion direction and exhibits change in an optical-path-length difference of the expanded light along the expansion direction; an image sensor configured to detect the expanded light; and a processing device configured to measure displacement on the measurement surface based on displacement of a peak position of an interference signal in an image detected by the image sensor.

According to the above aspect of the invention, a displacement measuring instrument that can simultaneously achieve high accuracy, wide measurable range, and low production cost without requiring mechanical operations can be provided.

### BRIEF DESCRIPTION OF DRAWINGS

FIG. 1 is a layout plan illustrating an arrangement of a first exemplary embodiment of the invention.

FIG. 2 is a schematic illustration of an optical-path-length difference of an expanded light created by mirrors of the first exemplary embodiment.

FIG. 3 is a schematic illustration of displacement measurement of the first exemplary embodiment.

FIG. 4 is another schematic illustration of displacement measurement of the first exemplary embodiment.

FIG. 5 is a layout plan illustrating an arrangement of a second exemplary embodiment of the invention.

FIG. 6 is a perspective view illustrating a multistep slanted mirror of the second exemplary embodiment.

FIG. 7 is a schematic illustration of displacement measurement of the second exemplary embodiment.

FIG. 8 is a schematic illustration of displacement measurement of the second exemplary embodiment.

FIG. 9 is another schematic illustration of displacement measurement of the second exemplary embodiment.

FIG. 10 is a layout plan illustrating an arrangement of a third exemplary embodiment of the invention.

FIG. 11 is a perspective view illustrating a multistep slanted mirror of the third exemplary embodiment.

FIG. 12 is a perspective view illustrating an aperture diaphragm of the third exemplary embodiment.

FIG. 13 is a perspective view illustrating another aperture diaphragm of the third exemplary embodiment.

FIG. 14 is a layout plan illustrating an arrangement of a fourth exemplary embodiment of the invention.

FIG. 15 is a perspective view illustrating a cylindrical lens array of the fourth exemplary embodiment.

FIG. 16 is a layout plan illustrating an arrangement of a fifth exemplary embodiment of the invention.

FIG. 17 is a layout plan illustrating an arrangement of a sixth exemplary embodiment of the invention.

FIG. 18 is another schematic illustration of displacement measurement of the sixth exemplary embodiment.

FIG. 19 is a layout plan illustrating an arrangement of a seventh exemplary embodiment of the invention.

FIG. 20 is a layout plan illustrating an arrangement of an eighth exemplary embodiment of the invention.

### DETAILED DESCRIPTION

### First Exemplary Embodiment

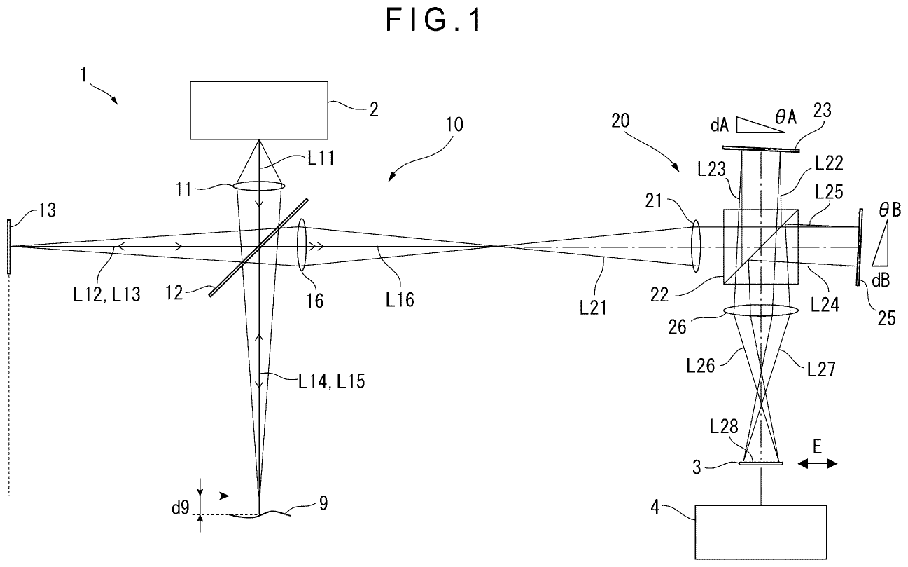

FIGS. 1 to 4 each illustrate a displacement measuring instrument 1 of a first exemplary embodiment of the invention.

As illustrated in FIG. 1, the displacement measuring instrument 1, which is configured to measure a displacement d9 of a workpiece 9, includes a light source 2, an image sensor 3, a processing device 4, a first interferometer 10, and a second interferometer 20.

The light source 2 is a light source device configured to generate a broadband source light L11 (e.g., white light).

The image sensor 3 is a one-dimensional or two-dimensional solid state image sensor in a form of a charge coupled device (CCD) image sensor and the like.

The processing device 4, which is a computer system operable in accordance with a predetermined operation program, is configured to process images detected by the image sensor 3 and calculate a displacement of the workpiece 9.

The first interferometer 10 includes an incident-side lens 11, a beam splitter 12, a reference-side mirror 13 that defines a reference surface, and an emission-side lens 16. A surface of the workpiece 9 (measurement target) is defined as a measurement surface.

In the first interferometer 10, the source light L11 emitted from the light source 2 is incident on the incident-side lens 11 to be transmitted therethrough, and split into a reference light L12 and a measurement light L14 by the beam splitter 12.

The reference light L12 is reflected by the reference-side mirror 13 to be returned to the beam splitter 12 as a reference light L13.

The measurement light L14 is reflected by the surface of the workpiece 9 (measurement surface) to be returned to the beam splitter 12 as a measurement light L15.

The reference light L13 and the measurement light L15 returned to the beam splitter 12 are mutually superimposed to form interference light L16, which is emitted from the emission-side lens 16 to the second interferometer 20.

The second interferometer 20 includes an incident-side lens 21, a beam splitter 22, a first mirror 23 that defines a first reflection surface, a second mirror 25 that defines a second reflection surface, and an emission-side lens 26.

The interference light L21 (L16) from the first interferometer 10 enters the incident-side lens 21. The interference light L21 transmitted through the incident-side lens 21, which is in a form of a beam having a predetermined optical path width, enters the beam splitter 22 to be split into a first split light L22 and a second split light L24.

The first split light L22 is reflected by the first mirror 23 to be returned to the beam splitter 22 as a first reflected light L23.

The second split light L24 is reflected by the second mirror 25 to be returned to the beam splitter 22 as a second reflected light L25.

The first mirror 23 and the second mirror 25 of the second interferometer 20 are configured as slanted mirrors that are slanted with respect to incident optical axes of the first split light L22 and the second split light L24, respectively.

The first mirror 23 is displaced such that the left end thereof is displaced upward in FIG. 1, with the right end serving as a center in FIG. 1. The first mirror 23 has a surface slanted by an angle θA with respect to a plane orthogonal to an incident optical axis of the first split light L22, where a displacement at the left end in FIG. 1 is defined as a distance dA. The first mirror 23 thus slanted creates an optical-path-length difference opdA, which is a distance 2dA between a component at the right end (in FIG. 1) and a component at the left end (in FIG. 1) of the first reflected light L23 having the predetermined optical path width and continuously changes from a distance 0 to the distance 2dA in the area from the right end to the left end. It should be noted that the optical-path-length difference opdA at the left end in FIG. 1, which, strictly speaking, is represented by dA[1+cos(2θA)], can be approximated as the distance 2dA because θA is sufficiently small.

The second mirror 25 is displaced such that the lower side thereof is displaced leftward in FIG. 1, with the upper end serving as a center in FIG. 1. The second mirror 25 has a surface slanted by an angle θB with respect to a plane orthogonal to an incident optical axis of the second split light L24, where a displacement at the lower side in FIG. 1 is defined as a distance dB. The second mirror 25 thus slanted creates an optical-path-length difference opdB, which is a distance 2dB between a component at the lower end (in FIG. 1) and a component at the upper end (in FIG. 1) of the second reflected light L25 having the predetermined optical path width and continuously changes between a distance 0 to the distance 2dB in the area between the upper end and the lower end. It should be noted that the optical-path-length difference opdB at the lower end in FIG. 1, which, strictly speaking, is represented by dB[1+cos(2θB)], can be approximated as the distance 2dB because θB is sufficiently small.

The first reflected light L23 and the second reflected light L25 returned to the beam splitter 22 are emitted from the emission-side lens 26 to the image sensor 3 as a first reflected light L26 and a second reflected light L27, respectively.

The optical axes of the first reflected light L23 and the second reflected light L25 are respectively offset with respect to optical axes of the original first split light L22 and second split light L24, so that the first reflected light L26 and the second reflected light L27 emitted from the beam splitter 22 are not mutually superimposed. The first reflected light L26 and the second reflected light L27 are superimposed when being incident on the surface of the image sensor 3 to form an expanded light L28 having a predetermined optical path width in an expansion direction E. The expanded light L28 expands in the predetermined expansion direction E. An optical-path-length difference opdC of the expanded light L28 varies along the expansion direction E.

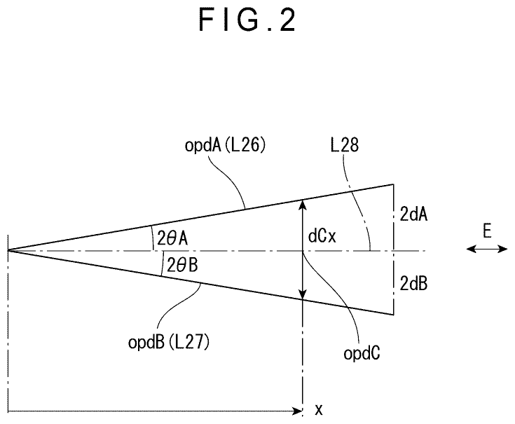

Here, traveling directions of the first reflected light L26 and the second reflected light L27 are slanted by 2θA and 2θB, respectively, with respect to the respective traveling directions of the reflected lights in a case where the first mirror 23 and the second mirror 25 have no inclinations, depending on the respective inclination angles θA and θB of the first mirror 23 and the second mirror 25. Therefore, as illustrated in FIG. 2, the first reflected light L26 and the second reflected light L27, which are superimposed to generate the expanded light L28, have optical-path-length differences opdA and opdB, respectively, of at most distances 2dA and 2dB on both sides in the expansion direction E, depending on the respective inclination angles 2θA and 2θB of the traveling directions of the first reflected light L26 and the second reflected light L27. Accordingly, the optical-path-length difference opdC, which is created in the expanded light L28 formed by superimposing the first and second reflected lights L26, L27, is equal to the sum of the optical-path-length differences opdA, opdB and varies continuously from a distance 0 to the distance 2dA+2dB from one end to the other end in the expansion direction E. The optical-path-length difference opdC of the expanded light L28 at a point remote from the one end in the expansion direction E by a distance x is defined as a distance dCx (0<dCx<2dA+2dB).

It should be noted that the inclination angles θA, θB of the first mirror 23 and the second mirror 25 and the distances 2dA, 2dB for defining the optical-path-length differences opdA, opdB may each be the same values. It is not necessary for both of the first mirror 23 and the second mirror 25 to be slanted but only one of the first and second mirrors 23, 25 may be slanted. In this case, the optical-path-length difference opdC of the expanded light L28 becomes equal to the optical-path-length difference of the slanted one of the mirrors (i.e., one of the optical-path-length differences opdA, opdB).

As described above, the interference light L21 incident on the second interferometer 20 is the interference light L16 emitted from the first interferometer 10, and the interference light L16 contains an interference signal whose optical-path-length difference corresponds to twice (round-trip) as large as the displacement d9 on the surface of the workpiece 9, which is the measurement surface of the first interferometer 10.

Interference fringes are generated by the expanded light L28 when the optical-path-length difference opdC is twice as large as the displacement d9 on the surface of the workpiece 9. The optical-path-length difference opdC at this time is the distance dCx=2d9, and therefore a point located away from the first end by the distance x in the expansion direction E can be specified.

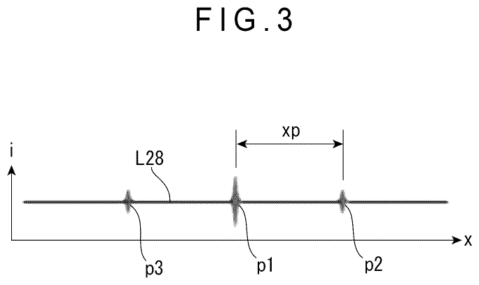

As illustrated in FIG. 3, at most three peaks of the interference signal appear in the expanded light L28 detected by the image sensor 3. In the graph of FIG. 3, the vertical axis represents the received optical signal intensity i detected by the image sensor 3, and the horizontal axis represents the distance x from a reference position in the expansion direction E.

When three peaks appear, a first peak p1 appearing at the center, which is a peak of the interference signal appearing at a point where the optical-path-length difference opdC of the second interferometer 20 is zero, appears constantly at the same point irrespective of the displacement d9 of the workpiece 9.

A second peak p2 and a third peak p3 appear at positions symmetrical to the left and right with respect to the central first peak p1. The second peak p2 and the third peak p3 appear at positions where a total optical-path-length difference, which is a combination of an optical-path-length difference of the first interferometer 10 (corresponding to the displacement d9 of the work 9) and an optical-path-length difference opdC of the second interferometer 20, becomes zero.

Both of a distance xp between the first peak p1 and the second peak p2 and a distance between the first peak p1 and the third peak p3 are proportional to the optical-path-length difference of the first interferometer 10 (i.e., the displacement d9 of the workpiece 9). Accordingly, for instance, the displacement d9 of the workpiece 9 can be calculated by measuring the distance xp between the first peak p1 and the second peak p2.

The position of the first peak p1 detected by the image sensor 3 can be selected by adjusting a relative positional relationship between the first mirror 23 and the second mirror 25, or by adjusting the image sensor 3 and/or the arithmetic unit 4.

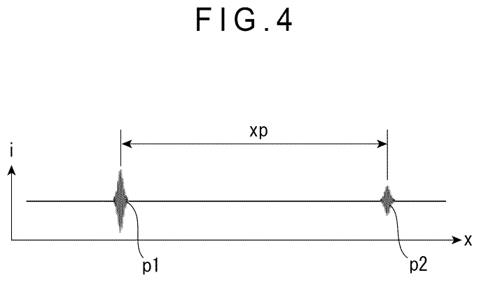

Two peaks (i.e., the first peak p1 and the second peak p2) can be displayed during a measurement process by bringing the position of the first peak p1 close to an end of a detectable area of the image sensor 3 as illustrated in FIG. 4. Such a setting allows the second peak p2 to be observed within the detectable range of the image sensor 3 even when the distance between the first peak p1 and the second peak p2 increases, so that the displacement d9 of the workpiece 9 can be measured over a wide range.

According to the exemplary embodiment, the following advantages can be achieved.

The displacement measuring instrument 1 of the exemplary embodiment includes: the light source 2 for generating the broadband source light L11; the first interferometer 10 for splitting the source light into reference light L13 and measurement light L15, to cause the reference light L13 to be incident on a reference surface (the reference-side mirror 13) and the measurement light L15 to be incident on a measurement surface (the surface of the workpiece 9), and to superimpose the reference light L13 and the measurement light L15 reflected from the reference surface and the measurement surface, respectively, to generate interference light L16; the second interferometer 20 for splitting the interference light L21 (L16), to cause the split interference light L21 (L16) to be incident on a first reflection surface (first mirror 23) and a second reflection surface (the second mirror 25), and to superimpose a first reflected light L23 reflected by the first reflection surface and a second reflected light L25 reflected by the second reflection surface to generate expanded light L28 that expands in a predetermined expansion direction E and exhibits change in an optical-path-length difference opdC along the expansion direction E; the image sensor 3 for detecting the expanded light L28; and the processing device 4 for measuring the displacement d9 of the measurement surface (i.e., the surface of the workpiece 9) based on the displacement of the peak positions (the first peak p1 and the second peak p2) of the interference signal in the image detected by the image sensor 3.

According to the above arrangement, the interference light L16 (L21) emitted from the first interferometer 10 is transmitted through the second interferometer 20, in which peaks of the interference signal are generated in the expanded light L28 at a position where the optical-path-length difference opdC in the second interferometer 20 is equal to twice the displacement d9 of the workpiece 9, and these peaks are detected as interference peaks in the image of the expanded light L28.

Specifically, the expanded light L28 expands in the expansion direction E, and as the optical-path-length difference opdC varies along the expansion direction E with distance dCx (0<dCx<2dA+2dB), a peak of the interference signal is generated at a point x where the condition dCx−2d9=0 is satisfied. On the image expanded in the expansion direction E (see FIG. 3), the interference peaks (the first peak p1 and the second peak p2) corresponding to the optical-path-length difference opdC and the displacement d9 are reflected on the expanded light L28, and the displacement d9 of the workpiece 9 (measurement surface) can be highly accurately measured based on the distance between the interference peaks on the image.

According to the above arrangement, since the interference peaks (the first peak p1 and the second peak p2) of the image of the expanded light L28 are measured, even signals continuously varying along the expansion direction E are measurable in one shot, and the mechanical operations and measurement time necessary as in existing time-domain displacement measuring instrument are not necessary. Further, the measurable range can be enlarged by magnifying the change in the distance dCx of the optical-path-length difference opdC of the expanded light L28 along the expansion direction E in the second interferometer 20.

According to the above arrangement, since the displacement d9 of the workpiece 9 (measurement surface) is measured based on the distance xp between the interference peaks (the first peak p1 and the second peak p2) on the image of the expanded light L28, highly accurate measurement can be stably performed even in the presence of error factors (e.g., temperature change).

The position of the first peak p1 and the second peak p2 detected by the image sensor 3 can be set by adjusting the relative positional relationship between the first mirror 23 and the second mirror 25, or by adjusting the image sensor 3 and/or the arithmetic unit 4.

At this time, when components of the displacement measuring instrument 1 are influenced by the temperature change, the positions of the first peak p1 and the second peak p2 detected by the image sensor 3 may change. If the measurement is performed solely using position information of a single interference peak (e.g., the first peak p1 or the second peak p2), the measurement accuracy is possibly deteriorated by errors caused by the change in the position information. However, according to the displacement measuring instrument 1 of the exemplary embodiment, since the distance xp (i.e., relative displacement between two interference peaks (the first peak p1 and the second peak p2)) is used, the error components are canceled at the time of calculating the distance xp even when the peaks changes due to temperature or the like, so that highly accurate measurement can be constantly and stably performed.

The second interferometer 20 of the exemplary embodiment includes the beam splitter 22 for splitting the interference light L21 to cause the interference light L21 to be incident on the first reflection surface (first mirror 23) and the second reflection surface (second mirror 25), where the first reflected light L26 (L23) and the second reflected light L27 (L25) are incident on the image sensor 3 via the beam splitter 22 and at least one of the first reflection surface (first mirror 23) or the second reflection surface (second mirror 25) is a slanted mirror that is arranged to be slanted in the expansion direction E with respect to the incident optical axis.

According to the above arrangement, the first interferometer 10 and the second interferometer 20 can be each implemented as a Twyman-Green interferometer. The slanted mirror defining one or both of the first reflection surface (first mirror 23) and the second reflection surface (second mirror 25) allows the optical-path-length difference opdA and/or opdB in the incident optical axis direction to be created by corresponding one of the surfaces along the slanted direction, making it possible to generate the expanded light L28 that expands in the predetermined expansion direction E and exhibits change in an optical-path-length difference opdC along the expansion direction E.

### Second Exemplary Embodiment

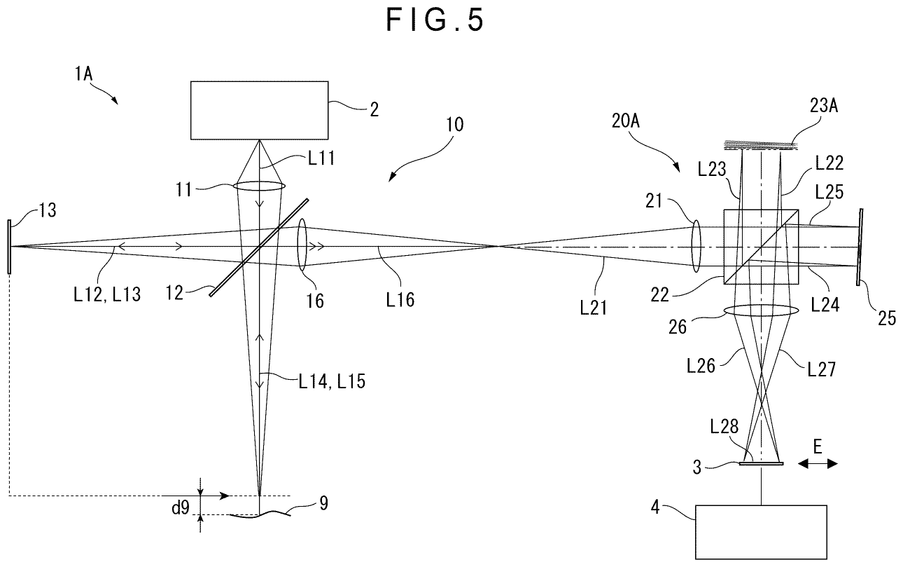

FIGS. 5 to 9 each depict a displacement measuring instrument 1A of a second exemplary embodiment of the invention.

A part of the components of the exemplary embodiment is different from that of the above-described first exemplary embodiment. The components common to both of the exemplary embodiments will be omitted and different component(s) will be described below.

As illustrated in FIG. 5, a displacement measuring instrument 1A, which is configured to measure the displacement d9 of the workpiece 9, includes the light source 2, the image sensor 3, the processing device 4, the first interferometer 10, and a second interferometer 20A.

In the above-described first exemplary embodiment, the first mirror 23, which is arranged to be slanted, is used as the first reflection surface of the second interferometer 20 (see FIG. 1). In contrast, the second interferometer 20A of the exemplary embodiment uses a multistep slanted mirror 23A as the first reflection surface.

It should be noted that the second mirror 25 serving as the second reflection surface of the second interferometer 20A is supposed not to be slanted (i.e., angle θB=0) hereinbelow for simplification, where the optical-path-length difference opdC=opdA is satisfied.

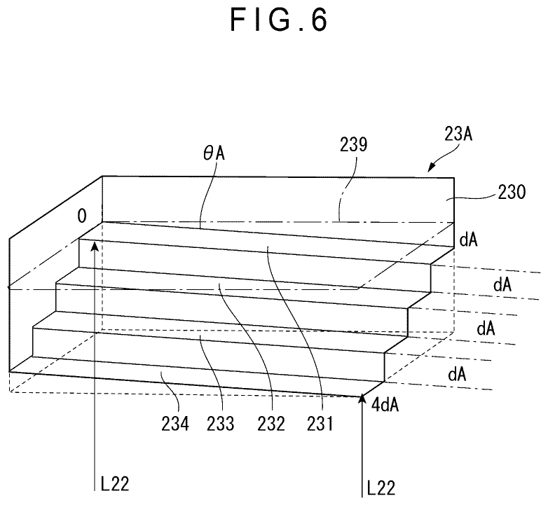

As illustrated in FIG. 6, the multistep slanted mirror 23A is provided by cutting a part of a rectangular parallelepiped base 230 to form steps (slant surfaces 231 to 234) and precisely polishing the surfaces to form a slanted mirror having high flatness.

The slanted surfaces 231 to 234 are each slanted by an angle θA with respect to a virtual reference surface 239 that is offset by a predetermined distance from a rear surface of the base 230. Due to this inclination, the slanted surfaces 231 to 234 have distances from the reference surface 239 of the respective surfaces that increase from one end (on the left side in the drawing) toward the other end (on the right side in the drawing), reaching a maximum change distance dA. The slant surfaces 231 to 234 are each offset stepwise by the distance dA.

The multistep slanted mirror 23A is installed such that the reference surface 239 is aligned with a plane orthogonal to the incident optical axis of the first split light L22. Each of the slant surfaces 231 to 234 thus serves as a similar slanted mirror corresponding to the first mirror 23 of the above-described first exemplary embodiment.

The offset distance dA of each of the slant surfaces 231 to 234 is the same as the maximum distance dA (change amount) of the slanted mirror. Accordingly, the change amount of the first split light L22 in the incident optical axis direction can be expanded from the distance dA (change amount per one surface) to distance 4dA (change amount of total four surfaces) by virtually sequentially connecting the slanted surfaces 231 to 234. Specifically, when the left end (in the drawing) of the slanted surface 231 is set to 0 for the change in the incident optical axis direction of the first split light L22, the right end (in the drawing) of the slanted surface 231 is at a distance dA, the left end (in the drawing) of the slanted surface 232 is at the same distance dA as the right end (in the drawing) of the slanted surface 231, and the right end (in the drawing) of the slanted surface 232 is at a distance 2dA. Similarly, by accumulating in this manner, the right end (in the drawing) of the slanted surface 234 becomes a distance 4dA.

Accordingly, when the first split light L22 is incident on the multistep slanted mirror 23A, the optical path length can be changed in a range from 0 to the distance 8dA (twice the maximum distance 4dA in the incident optical axis direction) at most depending on the incidence position on the entire surface composed of the slant surfaces 231 to 234.

Referring back to FIG. 5, the first reflected light L26 by the multistep slanted mirror 23A is incident on the image sensor 3 to be superimposed on the second reflected light L27 from the second mirror 25 to form the expanded light L28. In this case, when the image sensor 3 is provided as a two-dimensional image sensor, four stripes of the expanded light L28, which corresponds to four stripes of the first reflected light L26 reflected by the slant surfaces 231 to 234, are detectable on the image.

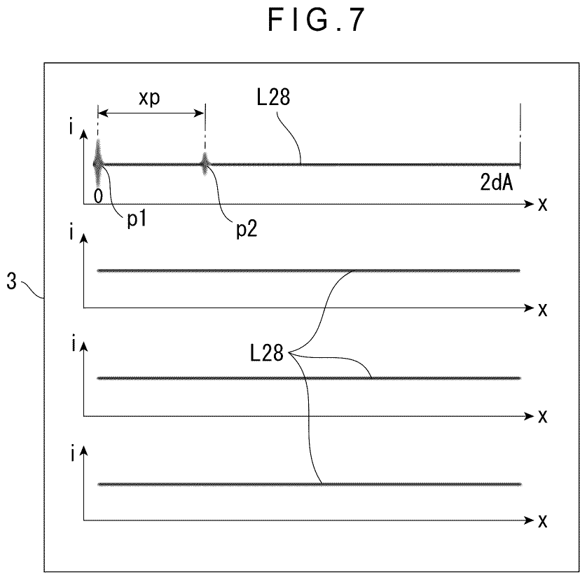

As illustrated in FIGS. 7 to 9, the four stripes of the expanded light L28 reflected by the slant surfaces 231 to 234 are detected by the image sensor 3.

Specifically, the slant surfaces 231 to 234 of the multistep slanted mirror 23A are each arranged in a direction intersecting the respective slanted directions and the incident optical axis of the first split light L22. Accordingly, the first reflected light L26 incident on the image sensor 3 from the slant surfaces 231 to 234 form four mutually parallel stripes extending in the slanted directions of the respective slant surfaces 231 to 234. Since the second reflected light L27 is uniformly distributed on the entire surface of the image sensor 3, the expanded light L28 generated in an overlapping area with the first reflected light L26 also appears in a form of four stripes corresponding to the first reflected light L26.

As described above, the optical-path-length created by the slant surfaces 231 to 234 changes in a range from 0 to the distance 8dA at most by sequentially connecting the images formed by the surfaces. Accordingly, the optical-path-length difference opdC of the expanded light L28 can be increased from 0 to the distance 8dA at most by sequentially connecting the four stripes of the expanded light L28 detected by the image sensor 3 and bringing the first peak p1 to be close to the left end (0 position) in the drawing.

As illustrated in FIG. 7, when the optical-path-length difference opdC of the expanded light L28 is in the range from 0 to 2dA, the peaks (the first peak p1 and the second peak p2) of the interference signal appear on the uppermost stripe of the expanded light L28.

When the optical-path-length difference opdC of the expanded light L28 is in the range exceeding 2dA to 4dA, the second peak p2 appears on the second stripe of the expanded light L28.

Accordingly, the displacement d9 of the workpiece 9 can be calculated by measuring the distance xp between the first peak p1 and the second peak p2 as in the above-described first exemplary embodiment.

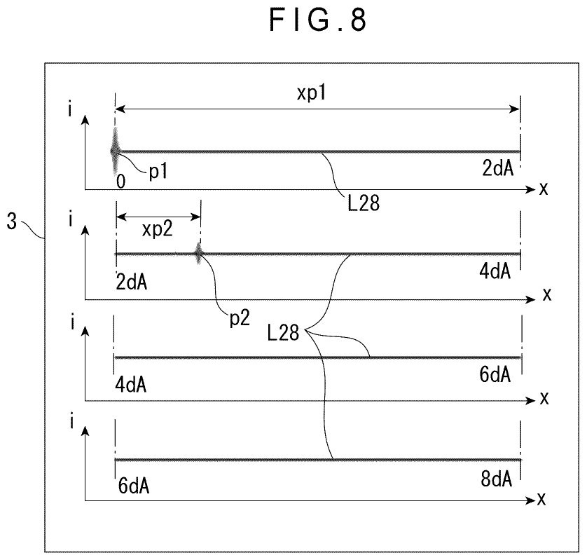

As illustrated in FIG. 8, when the optical-path-length difference opdC of the expanded light L28 exceeds the distance 2dA, though the first peak p1 stays at the same position, the second peak p2 appears on the second stripe of the expanded light L28.

In FIG. 8, a distance from the first peak p1 to a point at which the optical-path-length difference opdC on the uppermost stripe of the expanded light L28 reaches the distance 2dA is defined as a distance xp1 and a distance from the point located at the distance 2dA on the second stripe of the expanded light L28 to the second peak p2 is defined as a distance xp2. Here, the distance from the first peak p1 to the second peak p2 can be calculated by a formula: distance xp=xp1+xp2, where the displacement d9 of the workpiece 9 can be calculated based on the calculated distance xp.

Similarly, when the optical-path-length difference opdC of the expanded light L28 exceeds the distance 4dA, though the first peak p1 stays at the same position, the second peak p2 appears on the third stripe of the expanded light L28.

Further, when the optical-path-length difference opdC of the expanded light L28 exceeds the distance 6dA, though the first peak p1 stays at the same position, the second peak p2 appears on the fourth stripe of the expanded light L28.

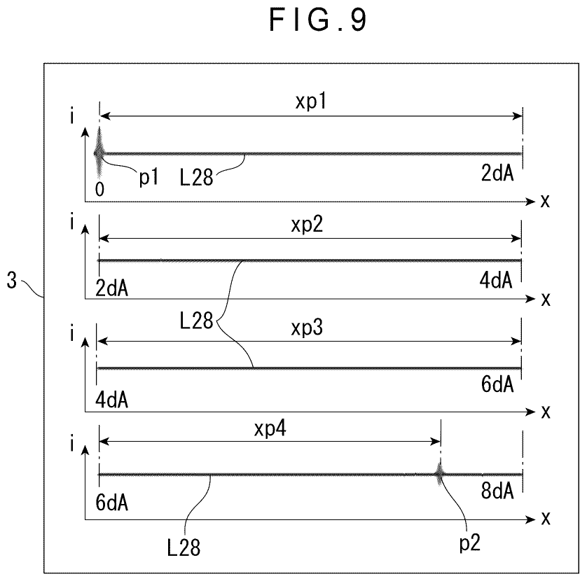

It is supposed in FIG. 9 that a distance from the first peak p1 to a point at which the optical-path-length difference opdC on the uppermost stripe of the expanded light L28 reaches the distance 2dA is the distance xp1, a distance from the point at which the optical-path-length difference opdC on the second stripe of the expanded light L28 reaches the distance 2dA to a point at which the optical-path-length difference opdC thereof reaches the distance 4dA is the distance xp2, a distance from the point at which the optical-path-length difference opdC on the third stripe of the expanded light L28 reaches the distance 4dA to a point at which the optical-path-length difference opdC thereof reaches the distance 6dA is a distance xp3, and a distance from the point at which the optical-path-length difference opdC on the fourth stripe of the expanded light L28 reaches the distance 6dA to the second peak p2 is a distance xp4. Here, the distance from the first peak p1 to the second peak p2 can be calculated by a formula: distance xp=xp1+xp2+xp3+xp4, where the displacement d9 of the workpiece 9 can be calculated based on the calculated distance xp.

Accordingly, even when the peak positions (the first peak p1 and the second peak p2) of the interference signal detected in the expanded light L28 are remote from each other and cannot be covered by the single slanted mirror (each of the slant surfaces 231 to 234), the peak positions can be detected by connecting the plurality of stripes, so that the measurable range of the expanded light L28 can be enlarged.

It should be noted that the second mirror 25, which serves as the second reflection surface of the second interferometer 20A and is supposed not to be slanted (i.e., angle θB=0) hereinabove for simplification, is optionally slanted by the angle θB as in the first exemplary embodiment. In this case, in the multistep slanted mirror 23A, although the slant surfaces 231 to 234 are offset in a stepped manner by distances dA, respectively, the optical-path-length difference opdC of the second interferometer 20A can be changed from 0 to the maximum distance of 8(dA+dB) by changing the distance dA to (dA+dB).

According to the exemplary embodiment, the following advantage can be achieved in addition to the same advantages as in the above-described first exemplary embodiment.

In the exemplary embodiment, the slanted mirror is the multistep slanted mirror 23A including a plurality of slanted mirrors (the slant surfaces 231 to 234) arranged in a direction intersecting the incident optical axis and the expansion direction (the slanted direction), the plurality of slanted mirrors being offset in the incident optical axis direction.

According to the above arrangement, by sequentially offsetting the slanted mirrors (the slant surfaces 231 to 234) at the respective steps in the optical axis direction, the optical-path-length difference opdC in the optical axis direction can be enlarged as an entirety of the multistep slanted mirror 23A, so that a wide measurable range incapable of being obtained by a single slanted mirror can be achieved.

### Third Exemplary Embodiment

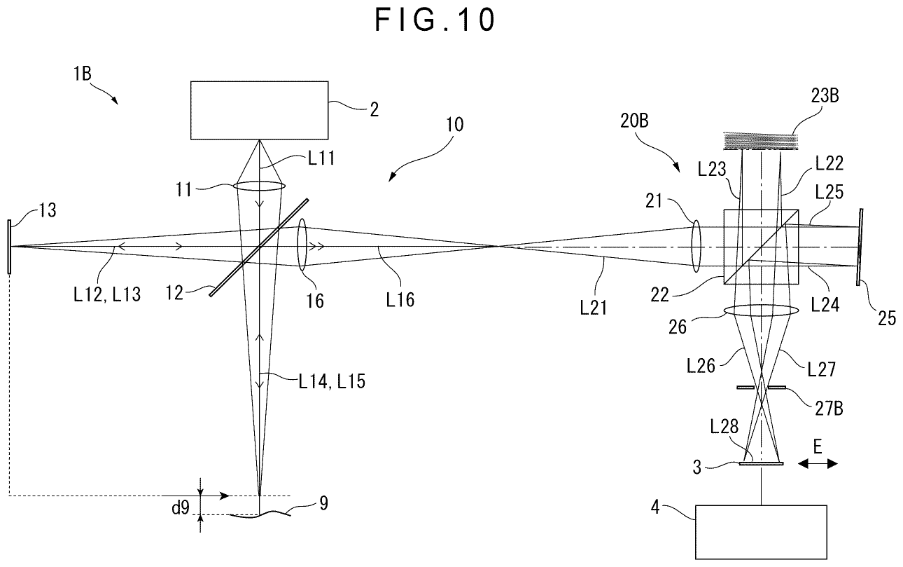

FIGS. 10 to 13 each depict a displacement measuring instrument 1B of a third exemplary embodiment of the invention.

A part of the components of the exemplary embodiment is different from that of the above-described first exemplary embodiment. The components common to both of the exemplary embodiments will be omitted and different component(s) will be described below.

As illustrated in FIG. 10, the displacement measuring instrument 1B, which is configured to measure the displacement d9 of the workpiece 9, includes the light source 2, the image sensor 3, the processing device 4, the first interferometer 10, and a second interferometer 20B.

In the above-described first exemplary embodiment, the first mirror 23, which is arranged to be slanted, is used as the first reflection surface of the second interferometer 20 (see FIG. 1). In contrast, the second interferometer 20B of the exemplary embodiment uses a multistep slanted mirror 23B as the first reflection surface. It should be noted that the second reflection surface of the second interferometer 20B of the exemplary embodiment is also defined as the slanted second mirror 25 as in the above-described first exemplary embodiment.

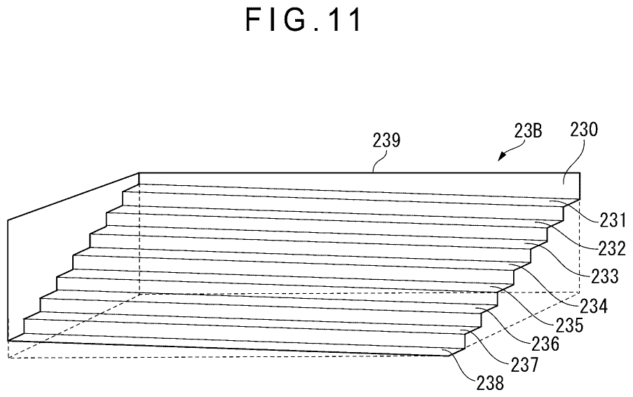

As illustrated in FIG. 11, the multistep slanted mirror 23B is provided by cutting a part of the rectangular parallelepiped base 230 to form steps (slant surfaces 231 to 238) and precisely polishing the surfaces to form slanted mirrors having high flatness.

While the multistep slanted mirror 23A (see FIG. 6) of the above-described second exemplary embodiment has four steps of the slanted mirrors (the slant surfaces 231 to 234), the multistep slanted mirror 23B of the exemplary embodiment has an increased number of steps, and the slanted mirrors (slant surfaces 231 to 238) are provided in eight steps. The structure of the multistep slanted mirror 23B of the exemplary embodiment is the same as the multistep slanted mirror 23A of the second exemplary embodiment except for the increased number of the steps.

Referring back to FIG. 10, the displacement measuring instrument 1B, whose multistep slanted mirror 23B has more number of steps of the slanted mirrors than the displacement measuring instrument 1A of the second exemplary embodiment, can further enlarge the measurable range.

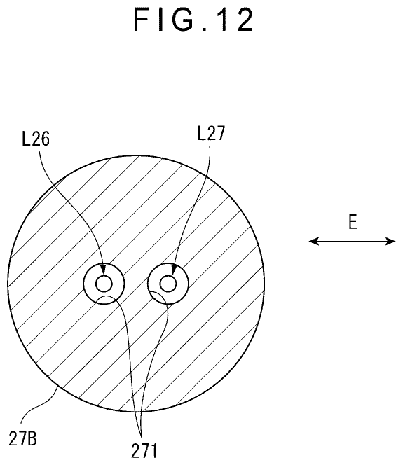

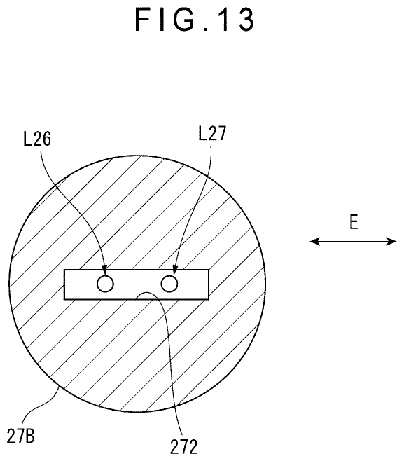

Herein, when the number of the steps of the slanted mirrors is increased as in the multistep slanted mirror 23B, the reflected lights from the respective steps of the slanted mirrors are significantly influenced by diffraction, sometimes causing defects on the image projected on the image sensor 3. In order to prevent the occurrence of the above disadvantage, the displacement measuring instrument 1B is provided with an aperture diaphragm 27B in a form of two holes (see FIG. 12) or a slit (see FIG. 13) between the image sensor 3 and the beam splitter 22.

The aperture diaphragm 27B illustrated in FIG. 12 has two circular holes 271 arranged along the expansion direction E. The first reflected light L26 and the second reflected light L27 are each transmitted through corresponding one of the circular holes 271 to be incident on the image sensor 3 in a restricted state.

The aperture diaphragm 27B illustrated in FIG. 13 has a slit 272 extending along the expansion direction E. The first reflected light L26 and the second reflected light L27 are transmitted through the slit 272 to be incident on the image sensor 3 in a restricted state.

According to the exemplary embodiment, the following advantage can be achieved in addition to the same advantages as in the above-described first and second exemplary embodiments.

In the exemplary embodiment, the aperture diaphragm 27B for regulating the first reflected light L26 and the second reflected light L27 is installed between the image sensor 3 and the beam splitter 22.

According to the above arrangement, large focal depth can be achieved by blocking the diffraction light derived from the structure of the multistep slanted mirror 23B, so that the reflected light from the multistep slanted mirror 23B, which has a large depth in the optical axis direction, can be clearly imaged, thereby achieving a larger measurable range.

### Fourth Exemplary Embodiment

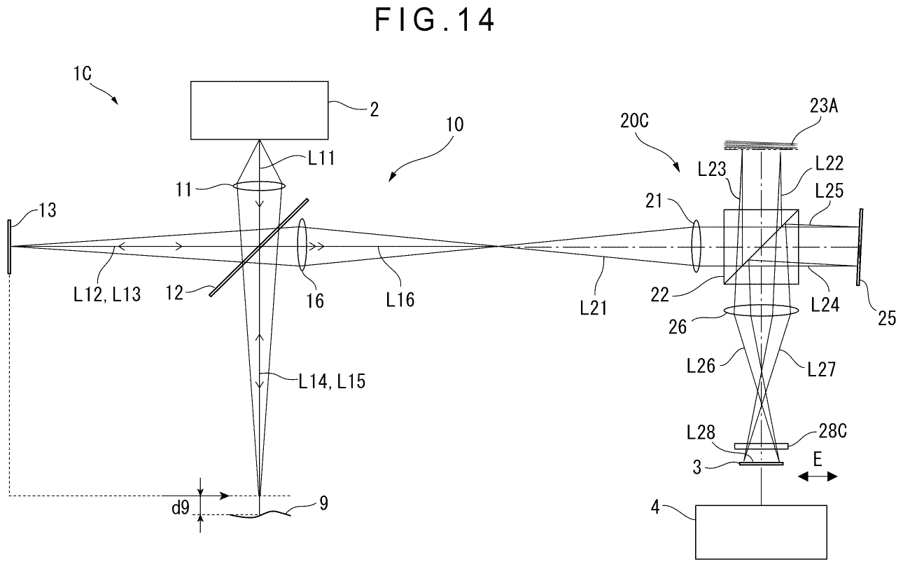

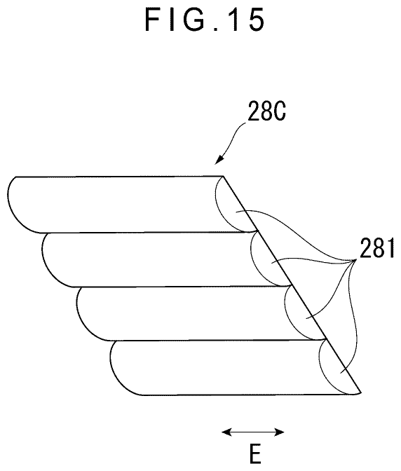

FIG. 14 to FIG. 15 each illustrate a displacement measuring instrument 1C of a fourth exemplary embodiment of the invention.

A part of the components of the exemplary embodiment is different from that of the above-described first exemplary embodiment. The components common to both of the exemplary embodiments will be omitted and different component(s) will be described below.

As illustrated in FIG. 14, the displacement measuring instrument 1C, which is configured to measure the displacement d9 of the workpiece 9, includes the light source 2, the image sensor 3, the processing device 4, the first interferometer 10, and a second interferometer 20C.

In the above-described first exemplary embodiment, the first mirror 23, which is arranged to be slanted, is used as the first reflection surface of the second interferometer 20 (see FIG. 1). In contrast, the second interferometer 20C of the exemplary embodiment uses the multistep slanted mirror 23A (as in the above-described second exemplary embodiment) to define the first reflection surface. It should be noted that the second reflection surface of the second interferometer 20C of the exemplary embodiment is also defined as the slanted second mirror 25 as in the above-described first exemplary embodiment.

The displacement measuring instrument 1C is further provided with a cylindrical lens array 28C between the image sensor 3 and the beam splitter 22.

As illustrated in FIG. 15, the cylindrical lens array 28C includes four cylindrical lenses 281 arranged in parallel along the expansion direction E. Each of the cylindrical lenses 281 condenses the first reflected light L26 from corresponding one of the slanted mirrors in four steps (slant surfaces 231 to 234) of the multistep slanted mirror 23A, thereby forming, together with the second reflected light L27 from the second mirror 25, four stripes of the expanded light L28 extending along the expansion direction E on the surface of the image sensor 3.

Due to the presence of the cylindrical lens array 28C, the light amount received by the image sensor 3 per a unit area can be increased to enhance the light intensity of the expanded light L28.

According to the exemplary embodiment, the following advantage can be achieved in addition to the same advantages as in the above-described first and second exemplary embodiments.

The cylindrical lenses 281 (the cylindrical lens array 28C) that are continuous in the expansion direction E and condense the incident light (the first reflected light L26 and the second reflected light L27) onto the image sensor 3 are provided in the exemplary embodiment.

According to the above arrangement, the incident light (the first reflected light L26 and the second reflected light L27) is condensed to enhance the light intensity when being received by the image sensor 3. In addition, with the use of the cylindrical lenses 281 that is continuous in the expansion direction E, it is possible to ensure properties of the expanded light L28 necessary for the measurement (i.e., expanding in the predetermined expansion direction E and exhibiting change in the optical-path-length difference opdC along the expansion direction E).

### Fifth Exemplary Embodiment

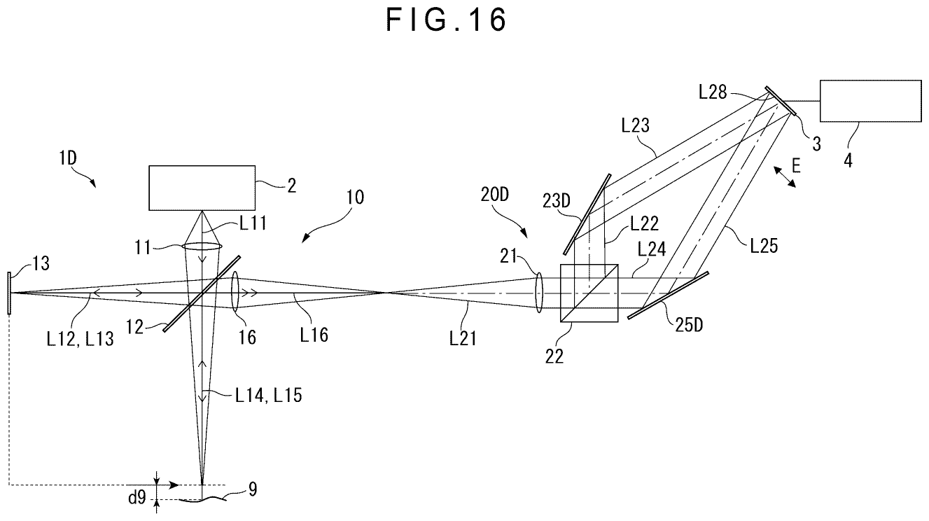

FIG. 16 illustrates a displacement measuring instrument 1D of a fifth exemplary embodiment of the invention.

A part of the components of the exemplary embodiment is different from that of the above-described first exemplary embodiment. The components common to both of the exemplary embodiments will be omitted and different component(s) will be described below.

As illustrated in FIG. 16, the displacement measuring instrument 1D, which is configured to measure the displacement d9 of the workpiece 9, includes the light source 2, the image sensor 3, the processing device 4, the first interferometer 10, and a second interferometer 20D.

In the above-described first exemplary embodiment, the first reflection surface and the second reflection surface of the second interferometer 20 are respectively the first mirror 23 and the second mirror 25 that are substantially orthogonal to and slightly slanted with respect to the first split light L22 and the second split light L24 from the beam splitter 22, where the first reflected light L23 and the second reflected light L25 are returned to the beam splitter 22 to form the second interferometer 20 in a form of a Twyman-Green interferometer (see FIG. 1).

In contrast, the second interferometer 20D of the exemplary embodiment is a two-optical-path-split one-way interferometer similar to a Mach-Zehnder interferometer. It should however be noted that, though the beams from two optical paths are superimposed by a beam splitter installed in front of the image sensor in the Mach-Zehnder interferometer, the beam splitter is omitted in the second interferometer 20D of the exemplary embodiment and the beams are superimposed on the image sensor 3.

Specifically, the second interferometer 20D of the exemplary embodiment includes a first mirror 23D and a second mirror 25D greatly slanted with respect to the first split light L22 and the second split light L24. The first mirror 23D and the second mirror 25D emit the first reflected light L23 and the second reflected light L25, respectively, in a direction opposite to the beam splitter 22, so that the lights are superimposed on the image sensor 3 to generate the expanded light L28.

In the second interferometer 20D, the first reflected light L23 and the second reflected light L25 to be incident on the image sensor 3 are turned into beams expanding in the expansion direction E by appropriately controlling the inclination angles of the first mirror 23D and the second mirror 25D. The optical path lengths of the first reflected light L23 and the second reflected light L25 are the same. In contrast, the incidence angle of the first reflected light L23 onto the image sensor 3 is defined to be different from the incidence angle of the second reflected light L25 onto the image sensor 3.

By superimposing the first reflected light L23 and the second reflected light L25 on each other, the expanded light L28 similar to that in the above-described first exemplary embodiment is generated. The interference signal (see FIG. 3) of the expanded light L28 is measured in the same manner as described in the first exemplary embodiment, which makes it possible to measure the displacement d9 of the workpiece 9 (measurement target).

Accordingly, even by the displacement measuring device 1D of the exemplary embodiment, the same advantages as in the above-described first exemplary embodiment can be achieved, and the following advantage can further be achieved.

The second interferometer 20D of the exemplary embodiment includes the beam splitter 22 for splitting the interference light L21 to cause the interference light L21 to be incident on the first reflection surface (first mirror 23D) and the second reflection surface (second mirror 25D). The first reflected light L23 and the second reflected light L25 are incident on the image sensor 3 without passing through the beam splitter 22, where the incidence angle of the first reflection light L23 onto the image sensor 3 is different from the incidence angle of the second reflection light L25 onto the image sensor 3.

According to the above arrangement, the first interferometer 10 is provided by a Twyman-Green interferometer and the second interferometer 20D is provided by a two-optical-path-split one-way interferometer similar to a Mach-Zehnder interferometer. With the use of the two-optical-path-split one-way interferometer, whose optical path is simpler than that of the Twyman-Green interferometer, the loss in the amount of the light reaching the image sensor 3 can be reduced.

In the second interferometer 20D, continuous optical-path-length difference opdC can be created on the expanded light L28 generated on the surface of the image sensor 3 by making the angles of incidence of the first reflected light L23 and the second reflected light L25 on the image sensor 3 different. In this case, by forming the image sensor 3 to be long in the expansion direction E, the optical-path-length difference opdC in the expanded light L28 can be increased, thereby extending the measurement range. Further, by using a one-dimensional sensor extending in the expansion direction E as the image sensor 3, the measurement operation can be further accelerated.

### Sixth Exemplary Embodiment

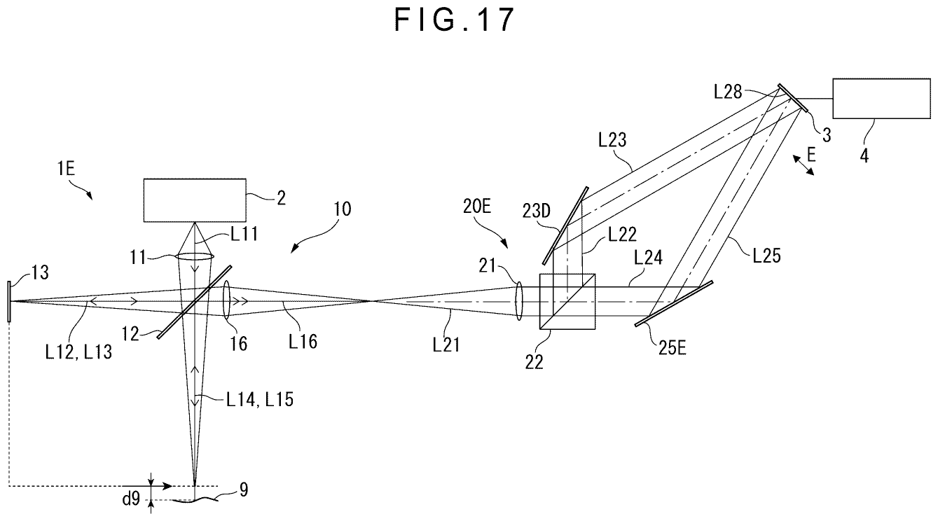

FIG. 17 illustrates a displacement measuring instrument 1E of a sixth exemplary embodiment of the invention.

A part of the components of the exemplary embodiment is different from that of the above-described fifth exemplary embodiment. The components common to both of the exemplary embodiments will be omitted and different component(s) will be described below.

As illustrated in FIG. 17, the displacement measuring instrument 1E, which is configured to measure the displacement d9 of the workpiece 9, includes the light source 2, the image sensor 3, the processing device 4, the first interferometer 10, and a second interferometer 20E.

The second interferometer 20E of the exemplary embodiment has a structure similar to that of the second interferometer 20D (see FIG. 16) of the above-described fifth exemplary embodiment. It should however be noted that, in the exemplary embodiment, a second mirror 25E is located further away from the beam splitter 22 as compared with the second mirror 25D of the fifth exemplary embodiment, thereby extending the optical path length of the second reflected light L25.

According to the displacement measuring instrument 1E of the exemplary embodiment, as described for the displacement measuring instrument 1D in the fifth exemplary embodiment, the displacement d9 of the workpiece 9 (measurement target) can be measured by measuring the interference signal of the expanded light L28 received by the image sensor 3 as in the displacement measuring instrument 1 of the above-described first exemplary embodiment.

Further, according to the displacement measuring instrument 1E of the exemplary embodiment, a projected position of the expanded light L28 received by the image sensor 3 can be shifted by changing the position of the second mirror 25E to extend the optical path of the second reflected light L25.

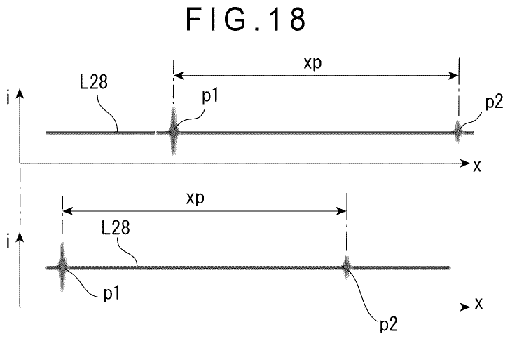

As illustrated in an upper diagram in FIG. 18, when the displacement d9 of the workpiece 9 is large, in the expanded light L28 obtained by the displacement measuring device 1D of the fifth embodiment, the interval between the interference signals becomes wide and may not fit within the width of the image sensor 3. According to the displacement measuring instrument 1E of the exemplary embodiment, by shifting the projected position of the expanded light L28 on the image sensor 3, as illustrated in a lower diagram in FIG. 18, even when the interval between the interference signals (i.e., the distance xp between the first peak p1 and the second peak p2) is wide, it can be detected in a single shot by the image sensor 3.

In the second interferometer 20E of the exemplary embodiment, the optical path length from the beam splitter 22 to the image sensor 3 via the first reflection surface (the first mirror 23D) and the optical path length from the beam splitter 22 to the image sensor 3 via the second reflection surface (the second mirror 25E) are different from each other.

According to the above arrangement, the peaks of the interference fringe appearing on the expanded light L28 received by the image sensor 3 can be shifted in the expansion direction E (i.e., the direction for the image sensor 3 to be elongated) by adjusting the location of the first reflection surface (the first mirror 23D) and the second reflection surface (the second mirror 25E) (i.e., changing the location of the second mirror 25E) to generate a difference in the optical path length of the reflected light between the first and the second reflection surfaces. For example, by shifting an interference signal peak (the first peak p1) serving as a reference indicating that the optical path difference opdC of the second interferometer 20 is zero to an end of a light receiving region, a longer optical path difference measurement width can be generated, and the measurement range can be extended.

### Seventh Exemplary Embodiment

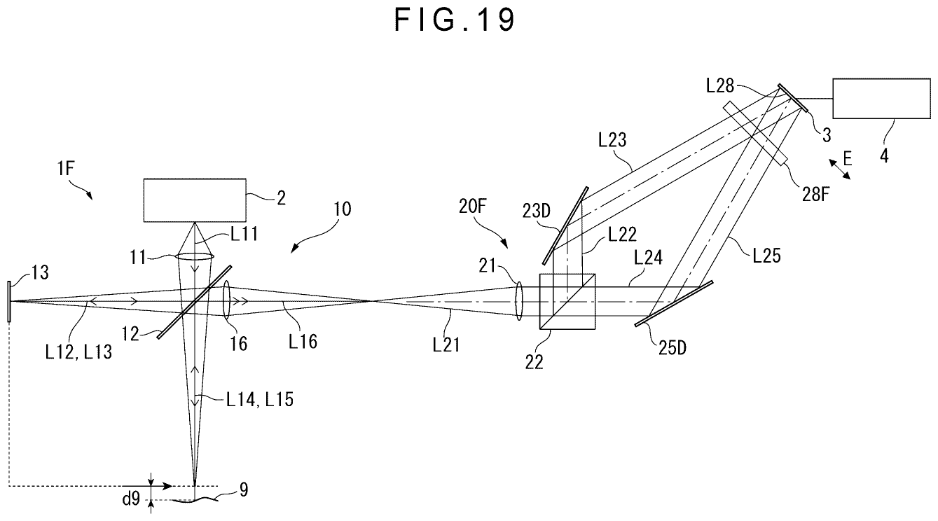

FIG. 19 illustrates a displacement measuring instrument 1F of a seventh exemplary embodiment of the invention.

A part of the components of the exemplary embodiment is different from that of the above-described fifth exemplary embodiment. The components common to both of the exemplary embodiments will be omitted and different component(s) will be described below.

As illustrated in FIG. 19, the displacement measuring instrument 1F, which is configured to measure the displacement d9 of the workpiece 9, includes the light source 2, the image sensor 3, the processing device 4, the first interferometer 10, and a second interferometer 20F.

The second interferometer 20F of the exemplary embodiment has a structure similar to that of the second interferometer 20E (see FIG. 17) of the above-described sixth exemplary embodiment. In addition, a cylindrical lens 28F is installed along the light-receiving surface of the image sensor 3 in the exemplary embodiment.

According to the exemplary embodiment, the following advantage can be achieved in addition to the same advantages as in the above-described fifth and sixth exemplary embodiments.

The cylindrical lens 28F that is continuous in the expansion direction E and condenses the incident light (the first reflected light L23 and the second reflected light L25) onto the image sensor 3 is provided in the exemplary embodiment.

According to the above arrangement, the incident light (the first reflected light L23 and the second reflected light L25) is condensed to enhance the light intensity when being received by the image sensor 3. In addition, with the use of the cylindrical lens 28F that is continuous in the expansion direction E, it is possible to ensure properties of the expanded light L28 necessary for the measurement (i.e., expanding in the predetermined expansion direction E and exhibiting change in the optical-path-length difference opdC along the expansion direction E).

### Eighth Exemplary Embodiment

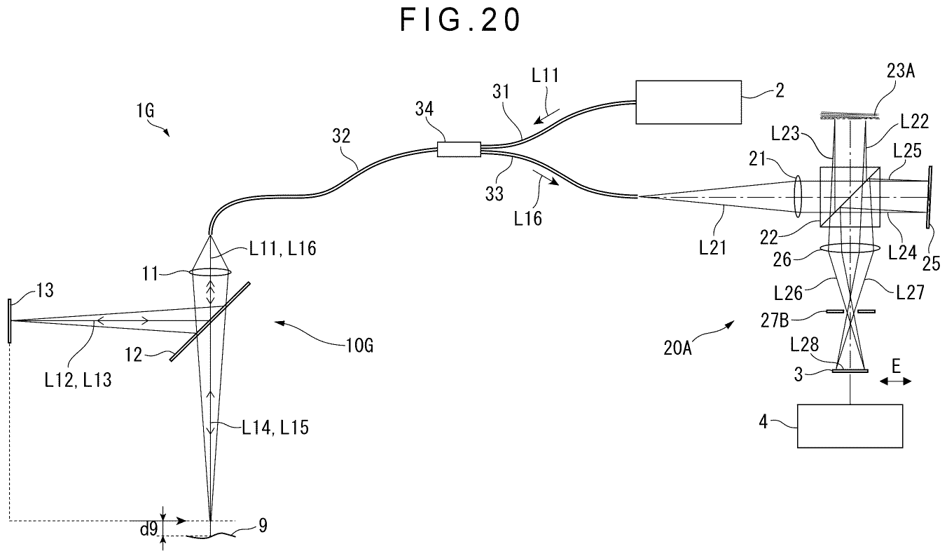

FIG. 20 illustrates a displacement measuring instrument 1G of an eighth exemplary embodiment of the invention.

A part of the components of the exemplary embodiment is different from that of the above-described second exemplary embodiment. The components common to both of the exemplary embodiments will be omitted and different component(s) will be described below.

As illustrated in FIG. 20, the displacement measuring instrument 1G, which is configured to measure the displacement d9 of the workpiece 9, includes the light source 2, the image sensor 3, the processing device 4, a first interferometer 10G, and the second interferometer 20A. Among the above, the light source 2, the image sensor 3, the processing device 4, and the second interferometer 20A are the same as those in the above-described second exemplary embodiment.

In the displacement measuring instrument 1G of the exemplary embodiment, the path from the light source 2 to the first interferometer 10G and the path from the first interferometer 10G to the image sensor 3 are provided by optical fibers 31, 32, 33 and a coupler 34.

The first interferometer 10G includes the incident-side lens 11, the beam splitter 12, and the reference-side mirror 13 that defines the reference surface. A surface of the workpiece 9 (measurement target) is defined as a measurement surface.

In the first interferometer 10G, the source light L11 emitted from the light source 2 is incident through the optical fibers 31, 32 on the incident-side lens 11 to be transmitted therethrough, and the source light L11 is split into the reference light L12 and the measurement light L14 by the beam splitter 12.

The reference light L12 is reflected by the reference-side mirror 13 to be returned to the beam splitter 12 as a reference light L13.

The measurement light L14 is reflected by the surface of the workpiece 9 (measurement surface) to be returned to the beam splitter 12 as a measurement light L15.

The reference light L13 and the measurement light L15 returned to the beam splitter 12 are mutually superimposed to form interference light L16. The interference light L16 is again transmitted through the incident-side lens 11 and then emitted through the optical fibers 32, 33 to the second interferometer 20A.

As described in the second exemplary embodiment, the interference light L16 emitted is detected as the expanded light L28 through the second interferometer 20A by the image sensor 3, thereby measuring the displacement d9 of the workpiece 9.

In the first interferometer 10G of the exemplary embodiment, the entrance of the source light L11 and the exit of the interference light L16 are at the same location, the path of the source light L11 from the light source 2 to the first interferometer 10G (the optical fibers 31, 32) and the path of the interference light L16 from the first interferometer 10G to the second interferometer 20A (the optical fibers 32, 33) are provided by the optical fibers 31, 32, 33, and parts of the optical fibers close to the first interferometer 10G (the optical fiber 32) are unified into a single fiber.

According to the above arrangement, the first interferometer 10G and the workpiece 9 can be located away from the light source 2 and the second interferometer 20A, so that the size of a probe including the first interferometer 10G can be reduced, thereby allowing the probe to be easily introduced even when the workpiece 9 is located in a narrow gap or the like.

### ADDITIONAL STATEMENT

The following additional statement relating to the above-described exemplary embodiments will be given below.

### Additional Statement 1

A displacement measuring instrument including:
a light source configured to generate broadband source light;
a first interferometer configured to split the source light into reference light and measurement light, to cause the reference light to be incident on a reference surface and the measurement light to be incident on a measurement surface, and to superimpose the reference light and the measurement light reflected from the reference surface and the measurement surface, respectively, to generate interference light;
a second interferometer configured to split the interference light, to cause the split interference light to be incident on a first reflection surface and a second reflection surface, and to superimpose a first reflected light reflected by the first reflection surface and a second reflected light reflected by the second reflection surface to generate expanded light that expands in a predetermined expansion direction and exhibits change in an optical-path-length difference of the expanded light along the expansion direction;
an image sensor configured to detect the expanded light; and
a processing device configured to measure displacement on the measurement surface based on displacement of a peak position of an interference signal in an image detected by the image sensor.

According to the above arrangement, the interference light from the first interferometer produces interference fringes, whose phase is different depending on the wavelength, in accordance with the displacement on the measurement surface. Accordingly, in time domain, the interference fringes appear only near an area where the optical-path-length difference is zero and no interference fringe is observable in other areas because the interference fringes at respective wavelengths cancel with each other. However, the interference fringe is observable by decomposing the interference fringe with respect to each of the wavelengths. Existing spectral-domain displacement measuring instrument uses a spectrometer to expand the interference light with respect to each of the wavelengths to detect the interference fringe.

According to the above arrangement, the interference light emitted from the first interferometer is transmitted through the second interferometer, and with respect to the optical path difference at the second interferometer generated in the expanded light, an interference signal peak is generated at a position where the optical path difference becomes equal to twice the displacement of the workpiece, and this interference peak is detected as an interference peak on the image of the expanded light. Specifically, the expanded light, which expands in the expansion direction and exhibits change in the optical-path-length difference along the expansion direction, can reflect the interference peak corresponding to the optical-path-length difference of the expanded light on the image expanded in the expansion direction, thereby allowing highly accurate measurement of the displacement on the measurement surface based on the interference peak on the image.

According to the above arrangement, since the interference peaks of the image of the expanded light are measured, even signals continuously varying along the expansion direction are measurable in one shot, and the mechanical operations and measurement time necessary as in existing time-domain displacement measuring instrument are not necessary. Further, the measurable range can be enlarged by magnifying the change of the optical-path-length difference of the expanded light along the expansion direction in the second interferometer.

According to the above arrangement, the displacement of the measurement surface is measured based on the distance between the interference peaks on the image of the expanded light, so that highly accurate measurement can be stably performed irrespective of the presence of error factors (e.g., temperature change). That is, when components of the displacement measuring instrument are influenced by the temperature change, the positions of the interference peaks detected by the image sensor are possibly shifted. If the measurement is performed solely using position information of a single interference peak, the measurement accuracy is possibly deteriorated by errors caused by the change in the position information. However, according to the above arrangement, which uses the distance (i.e., relative displacement between the two interference peaks), the error components are cancelled at the time of calculating the distance even when the peaks are shifted due to temperature, so that highly accurate measurement can be constantly and stably performed.

### Additional Statement 2

The displacement measuring instrument according to Additional Statement 1, in which the second interferometer includes a beam splitter configured to split the interference light and cause the split interference light to be incident on the first reflection surface and the second reflection surface,
the first reflected light and the second reflected light are incident on the image sensor via the beam splitter, and
at least one of the first reflection surface or the second reflection surface is a slanted mirror that is arranged to be slanted in the expansion direction with respect to an incident optical axis.

According to the above arrangement, the first interferometer and the second interferometer can be each implemented as a Twyman-Green interferometer. The slanted mirror defining one or both of the first reflection surface and the second reflection surface allows the optical-path-length difference in the incident optical axis direction to be created by corresponding one of the surfaces along the slanted direction, making it possible to generate the expanded light that expands in the predetermined expansion direction and exhibits change in an optical-path-length difference along the expansion direction.

### Additional Statement 3

The displacement measuring instrument according to Additional Statement 2, in which the slanted mirror is a multistep slanted mirror being a plurality of the slanted mirrors arranged in a direction intersecting the incident optical axis and the expansion direction, the slanted mirrors being offset in a direction of the incident optical axis.

According to the above arrangement, by sequentially offsetting the slanted mirrors at the respective steps in the optical axis direction, the optical-path-length difference in the optical axis direction can be enlarged as an entirety of the multistep slanted mirror, so that a wide measurable range incapable of being obtained by a single slanted mirror can be achieved.

### Additional Statement 4

The displacement measuring instrument according to Additional Statement 3, further including an aperture diaphragm provided between the image sensor and the beam splitter and configured to regulate the first reflected light and the second reflected light.

According to the above arrangement, large focal depth can be achieved by blocking the diffraction light derived from the structure of the multistep slanted mirror, so that the reflected light from the multistep slanted mirror, which has a large depth in the optical axis direction, can be clearly imaged, thereby achieving a larger measurable range.

### Additional Statement 5

The displacement measuring instrument according to Additional Statement 2, further including a cylindrical lens continuously extending in the expansion direction and configured to condense the incident light onto the image sensor.

According to the above arrangement, the incident light is condensed to enhance the light intensity when being received by the image sensor. In addition, with the use of the cylindrical lens that is continuous in the expansion direction, it is possible to ensure properties of the expanded light necessary for the measurement (i.e., expanding in the predetermined expansion direction and exhibiting change in the optical-path-length difference along the expansion direction).

### Additional Statement 6

The displacement measuring instrument according to Additional Statement 1, in which the second interferometer includes a beam splitter configured to split the interference light and cause the split interference light to be incident on the first reflection surface and the second reflection surface,
the first reflected light and the second reflected light are incident on the image sensor without passing through the beam splitter, and
an incidence angle of the first reflected light onto the image sensor is different from an incidence angle of the second reflected light onto the image sensor.

According to the above arrangement, the first interferometer is provided by a Twyman-Green interferometer and the second interferometer is provided by a two-optical-path-split one-way interferometer similar to a Mach-Zehnder interferometer. With the use of the two-optical-path-split one-way interferometer, whose optical path is simpler than that of the Twyman-Green interferometer, the loss in the amount of the light reaching the image sensor can be reduced.

In the second interferometer, continuous optical-path-length difference can be created on the expanded light generated on the surface of the image sensor by making the angles of incidence of the first reflected light and the second reflected light on the image sensor different. In this case, by forming the image sensor to be long in the expansion direction, the optical-path-length difference in the expanded light can be increased, thereby extending the measurement range. Further, by using a one-dimensional sensor extending in the expansion direction as the image sensor, the measurement operation can be further accelerated.

### Additional Statement 7

The displacement measuring instrument according to Additional Statement 6, in which an optical path length from the beam splitter via the first reflected surface to the image sensor is different from an optical path length from the beam splitter via the second reflected surface to the image sensor.

According to the above arrangement, the peaks of the interference fringe appearing on the expanded light received by the image sensor can be shifted in the expansion direction (i.e., the direction for the image sensor to be elongated) by adjusting the location of the first reflection surface and the second reflection surface to generate a difference in the optical path length of the reflected light between the first and the second reflection surfaces. For example, by shifting an interference signal peak serving as a reference indicating that the optical path difference of the second interferometer is zero to an end of a light receiving region, a longer optical path difference measurement width can be generated, and the measurement range can be extended.

### Additional Statement 8

The displacement measuring instrument according to Additional Statement 6, further including a cylindrical lens continuously extending in the expansion direction and configured to condense the incident light onto the image sensor.

According to the above arrangement, the incident light is condensed to enhance the light intensity when being received by the image sensor. In addition, with the use of the cylindrical lens that is continuous in the expansion direction, it is possible to ensure properties of the expanded light necessary for the measurement (i.e., expanding in the predetermined expansion direction and exhibiting change in the optical-path-length difference along the expansion direction).

### Additional Statement 9

The displacement measuring instrument according to Additional Statement 1, in which an entrance of the source light and an exit of the interference light are at the same location in the first interferometer, and
a path of the source light from the light source to the first interferometer and a path of the interference light from the first interferometer to the second interferometer are made of optical fibers, and portions of the optical fibers that are close to the first interferometer are bundled into a single fiber.

According to the above arrangement, the first interferometer and the workpiece can be located away from the light source and the second interferometer, so that the size of a probe including the first interferometer can be reduced, thereby allowing the probe to be easily introduced even when the workpiece is located in a narrow gap or the like.

What is claimed is

1. A displacement measuring instrument comprising:
a light source configured to generate broadband source light;
a first interferometer configured to split the source light into reference light and measurement light, to cause the reference light to be incident on a reference surface and the measurement light to be incident on a measurement surface, and to superimpose the reference light and the measurement light reflected from the reference surface and the measurement surface, respectively, to generate interference light;
a second interferometer configured to split the interference light, to cause the split interference light to be incident on a first reflection surface and a second reflection surface, and to superimpose a first reflected light reflected by the first reflection surface and a second reflected light reflected by the second reflection surface to generate expanded light that expands in a predetermined expansion direction and exhibits change in an optical-path-length difference of the expanded light along the expansion direction;
an image sensor configured to detect the expanded light; and
a processing device configured to measure displacement on the measurement surface based on displacement of a peak position of an interference signal in an image detected by the image sensor.

2. The displacement measuring instrument according to claim 1, wherein
the second interferometer comprises a beam splitter configured to split the interference light and cause the split interference light to be incident on the first reflection surface and the second reflection surface,
the first reflected light and the second reflected light are incident on the image sensor via the beam splitter, and
at least one of the first reflection surface or the second reflection surface is a slanted mirror that is arranged to be slanted in the expansion direction with respect to an incident optical axis.

3. The displacement measuring instrument according to claim 2, wherein the slanted mirror is a multistep slanted mirror comprising a plurality of the slanted mirrors arranged in a direction intersecting the incident optical axis and the expansion direction, the slanted mirrors being offset in a direction of the incident optical axis.

4. The displacement measuring instrument according to claim 3, further comprising an aperture diaphragm provided between the image sensor and the beam splitter and configured to regulate the first reflected light and the second reflected light.

5. The displacement measuring instrument according to claim 2, further comprising a cylindrical lens continuously extending in the expansion direction and configured to condense incident light onto the image sensor.

6. The displacement measuring instrument according to claim 1, wherein
the second interferometer comprises a beam splitter configured to split the interference light and cause the split interference light to be incident on the first reflection surface and the second reflection surface,
the first reflected light and the second reflected light are incident on the image sensor without passing through the beam splitter, and
an incidence angle of the first reflected light onto the image sensor is different from an incidence angle of the second reflected light onto the image sensor.

7. The displacement measuring instrument according to claim 6, wherein an optical path length from the beam splitter via the first reflected surface to the image sensor is different from an optical path length from the beam splitter via the second reflected surface to the image sensor.

8. The displacement measuring instrument according to claim 6, further comprising a cylindrical lens continuously extending in the expansion direction and configured to condense the incident light onto the image sensor.

9. The displacement measuring instrument according to claim 1, wherein an entrance of the source light and an exit of the interference light are at the same location in the first interferometer, and
a path of the source light from the light source to the first interferometer and a path of the interference light from the first interferometer to the second interferometer are made of optical fibers, and portions of the optical fibers that are close to the first interferometer are bundled into a single fiber.
